(19) United States
(12) Patent Application Publication
(10) Pub. No.: US 2008/0236166 A1
(43) Pub. Date: Oct. 2, 2008

(54) Moderate Temperature Heat Conversion Process

(76) Inventor: Walter Frederick Burrows, Greene, NY (US)

Correspondence Address: WALTER F. BURROWS, 1040 COUNTY ROAD 32, GREENE, NY, 13778, US

(21) Appl. No.: 11/695,516

(22) Filed: Apr. 2, 2007

(51) Int. Cl. F02G 5/00

(52) U.S. Cl. 60/750

(57) ABSTRACT

A process that can achieve thermally efficient conversion of heat energy to kinetic energy at moderate temperatures is disclosed in which alternating injections of hot and cool thermal fluid are made into a working gas. The thermal fluid on exiting the heat engine is thermally reconditioned with one or more heat pumps then sent back to the thermal fluid injectors.

### RELATED PATENT APPLICATION DATA

Not Applicable.

### FEDERALLY SPONSORED RESEARCH OR DEVELOPMENT

Not Applicable.

### SEQUENCE LISTING

Not Applicable.

### FIELD OF THE INVENTION

This invention relates to a process for converting heat energy to kinetic or mechanical energy.

### BACKGROUND OF THE INVENTION

Mankind has been interested in using heat to power various mechanical devices since ancient times. However, it took until the early eighteenth century before the first useful heat engines started to appear. In 1816, Robert Stirling invented the Stirling hot air engine. In 1877, Nikolaus Otto patented the four-stroke internal combustion engine. Since then many types of heat engines have been invented and many improvements have been made on each. Still only about 35% thermal conversion efficiency has been obtained in the most used heat engines. This difficulty is well understood and the second law of thermodynamics best explains it. This invention takes the approach that if high thermal conversion efficiency cannot be obtained by the heat engine and especially at moderate temperatures, then find a process that can do so.

The above and other objectives of the present invention will be come apparent from the following disclosure and illustrations.

### SUMMARY OF THE INVENTION

This invention discloses a process that can achieve thermally efficient conversion of heat energy to kinetic energy at moderate temperatures. This process is based on alternating injections of hot and cold thermal fluid into a pressurized gas or mixture of gases in the expandable chamber or chambers of a heat engine. That thermal fluid on exiting the heat engine is thermally reconditioned with one or more heat pumps and one or more heat make-up heat exchangers then sent back to the thermal fluid injectors. This invention can be more fully understood by reading the Detailed Description and viewing the drawings.

### BRIEF DESCRIPTION OF THE DRAWINGS

FIG. 1 is a schematic illustration of the type of equipment need to practice the process of this invention.

FIG. 2 is a graphic illustration of a Stirling Cycle.

### DETAILED DESCRIPTION

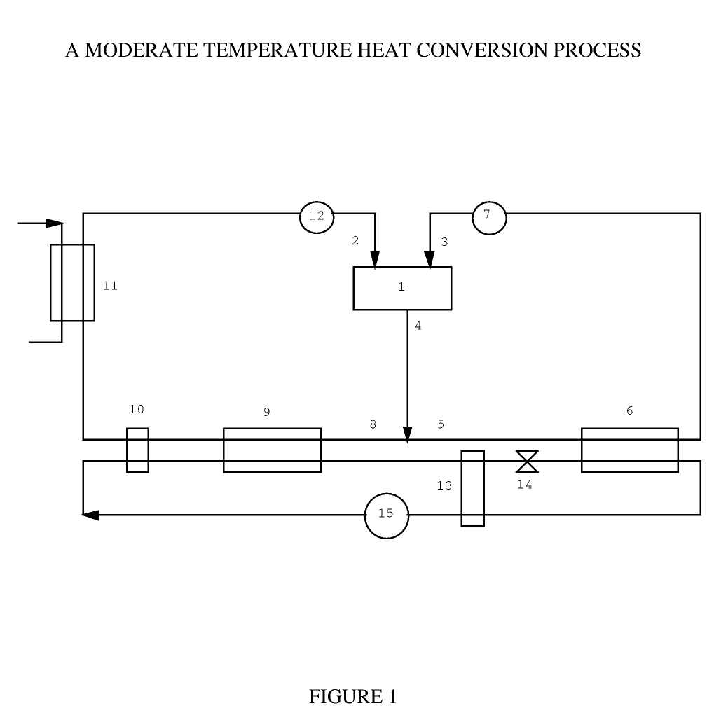

FIG. 1 is a schematic illustration of the type of equipment need to practice the process of this invention. Shown is a heat engine 1 having a hot thermal fluid injector 2 and a cold thermal fluid injector 3. The thermally altered thermal fluid exits the heat engine at 4 and then it is split into two portions 5 and 8. Thermal fluid portion 5 passes through the heat pump evaporator 6 where heat is removed to the desired temperature then it goes through fluid injector pump 7 and the cold thermal fluid injector 3. Fluid portion 8 passes through heat pump condenser 9, heat exchanger 10 and the heat make-up heat exchanger 11 taking on heat at each of these locations before going through fluid injector pump 12 and the hot thermal fluid injector 2. Also shown are the subcool heat exchanger 13, expansion valve 14, and refrigerant compressor 15.

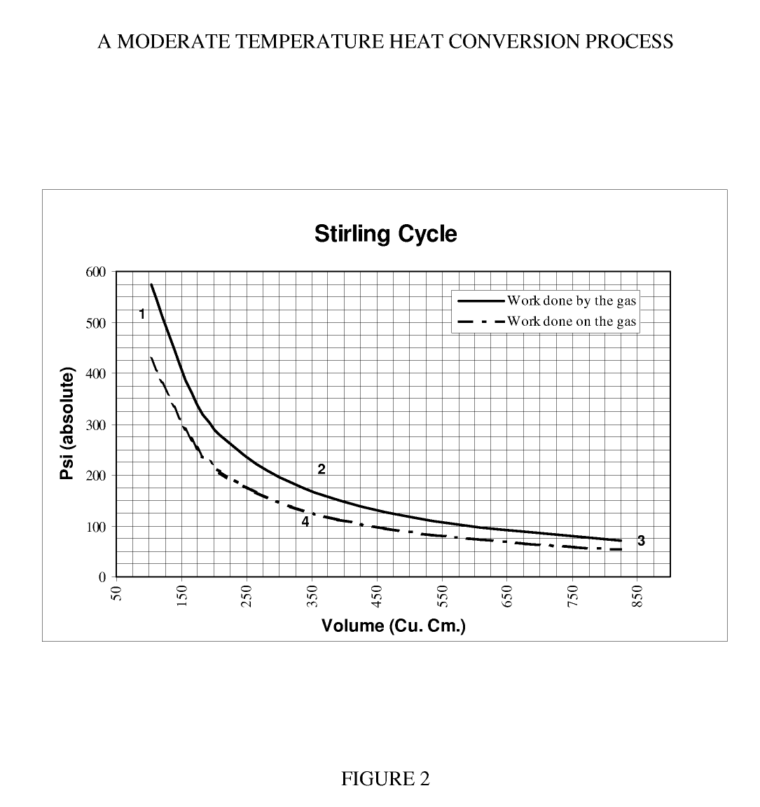

The preferred heat engines of this invention follow the Carnot or the Stirling cycle closely. Referencing FIG. 2, a graphic illustration of a Stirling cycle, a hot thermal fluid injection heats the cold compressed gas in the heat engine causing an isometric temperature rise 1 that is followed by an isothermal gas expansion 2. Then a cold thermal fluid injection cools the expanded gas in the heat engine causing an isometric temperature drop 3 that is follow by isothermal gas compression 4.

The difference between the work done by the isothermal expansion 2 of the gas and the work required for the isothermal compression of the gas 4 is the net work of the heat engine.

Table 1 contains data calculated for a two stroke, six cylinder heat engine operating according to the process of this invention. Examination of table 1 shows the following:
1. That more than half of the kinetic energy produced by the heat engine is used to drive the heat pump compressor while the remainder of the kinetic energy is available for outside work.
2. That the kinetic energy used by the heat pump compressor is returned to the process as thermal energy and the thermal efficiency of the process is near 100%.
3. That the make-up heat needed at any given time divided by 42.42 is equal to the net power output.
4. That doubling the operating speed of the engine or the operating pressures of the working gas doubles the kinetic power output of the process.

TABLE 1

| Example | 1 | 2 | 3 |
|---|---|---|---|
| Engine Parameters | | | |
| Number of Cylinders | 6 | 6 | 6 |
| Operating Speed (RPM) | 1800 | 3600 | 1800 |
| Bore (in.) | 4.00 | 4.00 | 4.00 |
| Cylinder Length @ Vmin (in.) | 0.50 | 0.50 | 0.50 |
| Cylinder Length @ Vmax (in.) | 4.00 | 4.00 | 4.00 |
| Operationing Pressure and | | | |
| Temperatures (° F.) | | | |
| Pressure @ Tmin-Vmax (Atm.) | 3.64 | 3.64 | 7.28 |
| Hot Working Gas | 10 | 10 | 10 |
| Cold Working Gas | −110 | −110 | −110 |
| Properties of System Componets | | | |
| Working Gas(s) | Helium | Helium | Helium |
| Name of Thermal Fluid | Methanol | Methanol | Methanol |
| Refrigerant | R508B | R508B | R508B |
| Isothermal Work Calculations | | | |
| (Btu./Min.) | | | |
| Work Done by the Gas | 8690 | 17380 | 17380 |
| Work Done on the Gas | 6470 | 12939 | 12939 |
| Net Work | 2220 | 4441 | 4441 |
| Heat Requirements (Btu./Min.) | | | |
| Heat Required to Raise Gas from | 1604 | 3207 | 3207 |
| Tmin to Tmax | | | |
| Heat Required for Work Done by Gas | 8690 | 17380 | 17380 |
| Total Heat Required | 10294 | 20587 | 20587 |
| Cooling Requirements (Btu/Min.) | | | |
| Cooling Required to Lower Gas from | 1604 | 3207 | 3207 |
| Tmax to Tmin | | | |
| Cooling Required for Work Done | 6470 | 12939 | 12939 |
| on Gas | | | |
| Total Cooling Required | 8073 | 16147 | 16147 |
| Condenser | | | |
| Condensation Temp. (° F.) | −10 | −10 | −0 |
| Condenser Pressure (psia) | 212 | 212 | 212 |
| Heat Transfer Loads (Btu/min) | | | |
| Condenser | 3870 | 7740 | 7069 |
| Evaporator | 3549 | 7097 | 7097 |
| Compressor | 1371 | 2742 | 2742 |
| Make-up Heat Exchanger | 849 | 1699 | 1699 |
| Work (Hp) | | | |
| Engine Output | 52.3 | 104.7 | 104.7 |
| Heat Pump Work | 32.3 | 64.6 | 64.6 |
| Net Power Output | 20.0 | 40.0 | 40.0 |
| Heat Conversion by Heat Engine¹ | 26% | 26% | 26% |
| Heat Conversion by Heat Engine | 100% | 100% | 100% |
| System² | | | |
| Make-up Heat to Add per Net | 42.42 | 42.42 | 42.42 |
| Horsepower (Btu.)³ | | | |

What is claimed is:

1. A heat to kinetic energy conversion process in which alternating injections of hot and cool thermal fluid are made into a pressurized gas or mixture of gases in the expandable chamber or chambers of a heat engine where;
a) The thermal fluid on exiting the heat engine is thermally reconditioned with one or more heat pumps and one or more heat make-up heat exchangers then sent back to the thermal fluid injectors.
